(19) United States
(12) Patent Application Publication
(10) Pub. No.: US 2026/0042365 A1
(43) Pub. Date: Feb. 12, 2026

(54) CLOSING DEVICE FOR A CHARGING OPENING OF A MOTOR VEHICLE

(71) Applicant: BOS GmbH & Co. KG, Ostfildern (DE)

(72) Inventor: Christian SCHRECK, Ostfildern (DE)

(21) Appl. No.: 19/254,140

(22) Filed: Jun. 30, 2025

(30) Foreign Application Priority Data
Aug. 7, 2024 (DE) 102024122573.4

(51) Int. Cl. B60L 53/16; H01R 13/52; H01R 13/66; H01R 13/70

(52) U.S. Cl. CPC B60L 53/16; H01R 13/5213; H01R 13/6683; H01R 13/701; H01R 2201/26

(57) ABSTRACT

A closing device for a charging opening of a motor vehicle having a closing cover and a guide device fixed to the vehicle. The guide device moves the closing cover between a closed position sealing the charging opening and an open position moved inwards behind an outer bodywork surface relative to the charging opening. The closing cover has an outer panel matched to the outer bodywork surface and a carrier slide on which the outer panel is held. The closing device includes a drive device for moving the closing cover between the closed and open positions, and an electric switching element for activating the drive device. The outer panel is mounted movably relative to the carrier slide, and the switching element is arranged between the outer panel and the carrier slide such that a pressure applied from outside onto the outer panel leads to an actuation of the switching element.

### CROSS-REFERENCE TO RELATED APPLICATION

This claims priority from German Application No. 102024122573.4, filed Aug. 7, 2024, the disclosure of which is hereby incorporated by reference in its entirety.

### TECHNICAL FIELD

The invention relates to a closing device for a charging opening of a motor vehicle, having a closing cover and having a guide device-arranged fixed to the vehicle in the state assembled ready for operation-which is coupled to the closing cover for moving the closing cover between a closed position sealing the charging opening and an open position moved inwards behind an outer bodywork surface relative to the charging opening, wherein the closing cover has an outer panel matched to the outer bodywork surface and a carrier slide on which the outer panel is held, and having a drive device for moving the closing cover between the closed position and the open position, and having an electric switching element provided for activation of the drive device.

### BACKGROUND AND SUMMARY

A closing device of this type is known from DE 10 2015 206 715 A1. The known closing device has a closing cover which seals the charging opening of the motor vehicle in a closed position and exposes it in an open position. In the open position, the closing cover is moved behind an outer bodywork surface that surrounds the charging opening. The closing cover has a carrier slide movable along a guide device and an outer panel, held on the carrier slide, which in the closed position of the closing cover is flush with the outer bodywork surface surrounding the charging opening. An actuator, which is activatable by means of a switching element, is provided for moving the closing cover between the closed position and the open position. The switching element is positioned stationary in the region of the charging opening. The switching element is here arranged inside the charging opening such that it is covered by the closing cover in the closed position of the latter. The switching element is actuated by a pressure applied from the outside onto the closing cover in its closed position, whereby the actuator is activated for moving the closing cover.

One object of the invention is to provide a closing device of the type mentioned at the outset which permits good use of the installation space of the charging opening.

This is achieved in that an outer panel is mounted movable relative to the carrier slide, and in that the switching element is arranged between the outer panel and the carrier slide with the effect that a load applied from the outside onto the outer panel leads to an actuation of the switching element. In accordance with the invention, the switching element is integrated in the closing cover and is carried along with the closing cover during an opening movement of the latter. It is sufficient here when an effective switching member or sensor part of the switching element is positioned between the outer panel and the carrier slide. Another part of the switching element may be arranged preferably on the carrier slide on a side opposite to the outer panel. A load in the meaning of the invention is understood to be in particular a manual load, preferably a pressure, applied by an operator from outside the motor vehicle. In contrast to the prior art, no restrictions on the use of the installation space for the charging opening result from the invention. This is because in the prior art, the switching element is positioned stationary in the region of the charging opening, so that accessibility to a corresponding charging connection surrounded by the charging opening is restricted. This is not the case with the solution in accordance with the invention. The solution in accordance with the invention is, in particular, advantageously suitable for a charging opening used as a power charging opening to supply electric power for a storage battery of the motor vehicle. In the same way, the solution in accordance with the invention is however also usable for motor vehicles of which the charging opening is provided for surrounding a nozzle for fossil fuels or for hydrogen. The arrangement of the effective part of the switching element between the outer panel and the carrier slide facilitates an at least largely complete pre-assembly of the closing device before the closing device is fitted ready for operation in the region of the charging opening of the motor vehicle. The switching element may be advantageously fitted either on the inside of the outer panel or on the carrier slide. Alternatively, the switching element may be fastened on an intermediate section between the outer panel and the carrier slide. The switching element may also be fastened to the rear of the carrier slide and protrude with its effective section through a passage in the carrier slide up to the outer panel. The charging opening is also referred to as a power charging opening.

In one embodiment of the invention, the switching element is fastened to the carrier slide. This embodiment is advantageous since the outer panel is made as a separate component and is detachably or undetachably connectable to the carrier slide for movement, in particular swivel movement. The switching element is accordingly already fastenable on the carrier slide in a first step, before the outer panel is then fitted movably onto the carrier slide. This permits a dependable fitting of the switching element in an easily electrically contactable manner.

In a further embodiment of the invention, the switching element is coupled wirelessly or by wire to a control unit that controls the drive device. An electric actuator is preferably provided as the drive device. The control unit is designed electrical and/or electronic. In the case of a wired coupling of the switching element to the control unit, corresponding electrical lines are carried along when the carrier slide, and hence the closing cover, is moved. In the case of a wireless coupling of the switching element to the control unit, the laying of electrical lines between the switching element and the control unit may be dispensed with.

In a further embodiment of the invention, the switching element has a mechanical switching member or a Hall sensor or another sensor element for detecting a movement of the outer panel. A linearly movable button, elastically resettable by spring force and triggering an electrical switching operation when appropriate pressure is applied, is preferably provided as the mechanical switching member.

In a further embodiment of the invention, the outer panel is associated with a spring arrangement which effects an forced resetting of the outer panel into a non-loaded initial position as soon as the load from outside is no longer being applied. The spring arrangement is preferably designed as a helical compression spring positioned between the carrier slide and the outer panel. The spring arrangement ensures that the outer panel in the non-loaded closed position is flush with the outer bodywork surface in the region of the charging opening, and that a visually attractive impression of the bodywork silhouette is assured.

### BRIEF DESCRIPTION OF THE DRAWINGS

FIG. 1 shows in a schematical sectional view an embodiment of a closing device in accordance with the invention, in the state fitted ready for operation, in a closed position, in the region of a charging opening of a motor vehicle;

FIG. 2 the closing device according to FIG. 1 in an actuation position; and

FIG. 3 the closing device according to FIGS. 1 and 2 in an open position.

### DETAILED DESCRIPTION

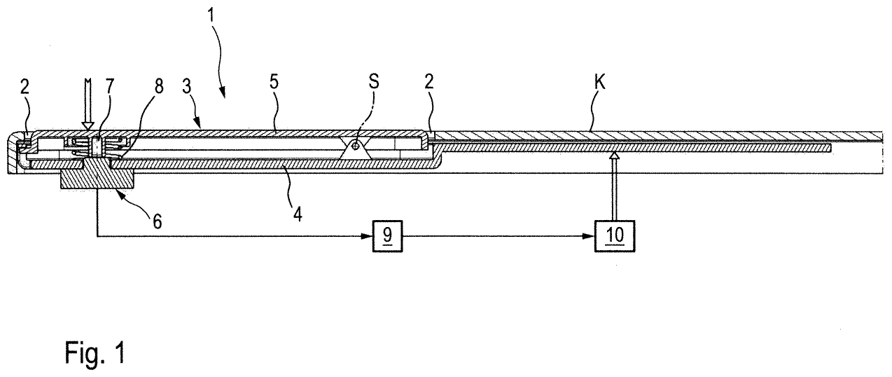

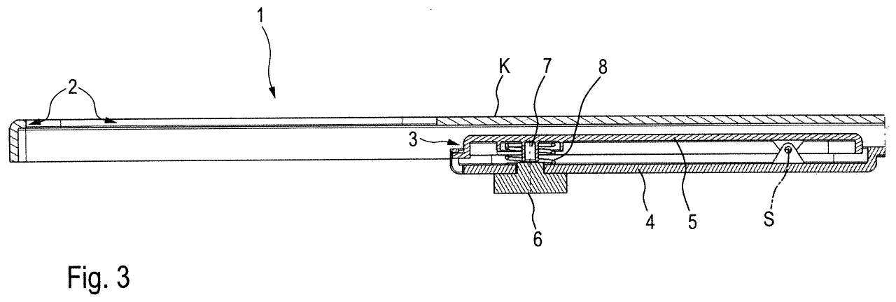

A passenger vehicle has, in a manner not shown in detail, an electric drive powered by means of a storage battery on the vehicle side. The storage battery is charged using a power charging connection on the vehicle side. The power charging connection is positioned in the region of a charging recess of a charging opening 2 in an outer bodywork surface K of a vehicle body of the passenger vehicle. The charging opening 2, which is also referred to as a power charging opening, is sealable or exposable by a closing cover 3. In a closed position, the closing cover 3 seals the charging opening 2 flush with the outer bodywork surface K, as may be discerned in FIG. 1. In an open position (FIG. 3), the closing cover 3 exposes the charging opening 2 in the outer bodywork surface K, to permit use of the power charging connection by connecting it to a charging cable. As may be seen in FIGS. 1 and 3, the closing cover 3 closes the charging opening 2 flush with the outer bodywork surface K in the closed position (FIG. 1), such that access to the power charging connection (not shown) of the charging recess adjoining the charging opening 2 on the inside is not possible. In the open position (FIG. 3), the closing cover 3 is moved on the one hand inwards towards the middle of the vehicle, relative to the charging opening 2, and on the other hand, on an inner face of the outer bodywork surface K, parallel to an opening plane of the charging opening 2 and out of the alignment of the charging opening 2, to one side such that the closing cover 3 is concealed behind the outer bodywork surface K surrounding the charging opening 2.

The closing cover 3 is formed by a carrier slide 4 and by an outer panel 5 held on the carrier slide 4. The outer panel 5 is with its outer face flush and aligned with the outer bodywork surface K as soon as the closing cover 3 is in the closed position. The outer panel 5 is held on the carrier slide 4 in a limitedly swivelable manner by means of a swivel mounting S. The swivel mounting S is positioned in a cavity created between and inner face of the outer panel 5 and an outer face of the carrier slide 4. The carrier slide 4 is, by means of a guide device not shown in detail, on the one hand movable inwards to a limited extent, relative to the charging opening 2, in the direction of the center of the vehicle, and on the other hand linearly movable along the inner face of the outer bodywork surface K and parallel to the opening plane of the charging opening 2. The guide device, not shown, has for that purpose at least one guide rail, fixed to the vehicle in the state assembled ready for operation, that effects a corresponding forced guidance of the carrier slide 4.

The carrier slide 4, and hence also the closing cover 3, are moved along the guide device by means of a drive device 10 indicated schematically in FIG. 1. The drive device 10 has, in a manner not described in detail, an electric actuator that effects the movement of the carrier slide 4 along the guide device between the open position and the closed position of the closing cover 3.

A control unit 9 positioned on the vehicle side is provided for activation of the drive device 10. The control unit 9 is coupled to an electric switching element 6 which is fastened to the carrier slide 4. The switching element 6 is here fastened to the carrier slide 4 on the back of the outer panel 5. The carrier slide 4 has a passage, (not described in detail), through which a part, effective as a sensor, of the switching element 6 protrudes towards the outer panel. The switching element 6 has, as a part effective as a sensor, a button 7 movable orthogonally to the opening plane of the charging opening 2 and closing a corresponding circuit inside the switching element 6, in order to pass on to the control unit 9 the required switching signal for activation of the drive device 10. The button 7 is in positive, non-positive or bonded contact with a receptacle on the inner face of the outer panel 5, such that a manual pressure movement applied from the outside to the outer panel 5 leads to an actuation of the button 7 and accordingly to a switching operation of the switching element 6. The switching element 6 and the button 7 are positioned on the carrier slide 4 at a distance from the swivel axis S of the outer panel 5, such that when a manual pressure is applied from the outside to the outer panel 5, the outer panel 5 swivels about the swivel axis S and actuates the switching element 6. To ensure that the outer panel 5 is flush with the outer bodywork surface K again in the closed position of the closing cover 3 after the manual pressure is removed, a spring arrangement 8 acting as a reset spring is associated with the outer panel 5 and is designed in the example shown as a helical compression spring positioned coaxially to the button 7. The helical compression spring rests on an outer face, facing the charging opening 2, of the carrier slide 4 on the one side, and on the inner face of the outer panel 5 on the other side.

Stops, not described in detail, on the outer panel 5 and on the carrier slide 4 ensure that the outer panel 5 cannot be forced by the pressure of the spring arrangement 8 any further outwards relative to the carrier slide 4 than is limited by the stop of the carrier slide 4. In the non-loaded rest position of the outer panel 5, the spring arrangement 8 accordingly forces the outer panel 5 outwards against the stop, not described in detail, of the carrier slide 4, such that the outer panel 5 is aligned parallel to the carrier slide 4 and flush with the outer bodywork surface K as soon as the closing cover 3 is in its closed position.

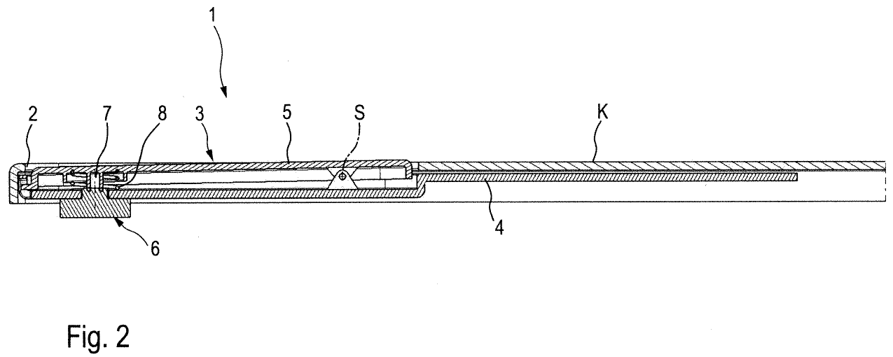

When the closing cover 3 is to be opened from its closed position according to FIG. 1, a manual pressure is exerted as a load onto the outer face of the outer panel 5 in the region of the arrow shown in FIG. 1 whereby the outer panel 5 is swiveled slightly inwards according to FIG. 2. This forces the button 7 inwards and actuates the switching element 6. Due to the actuation of the switching element 6, a switching signal is transmitted to the control unit 9 and is converted by the control unit 9 into a control signal for the drive device 10 so that the carrier slide 4 can be moved. The carrier slide 4 is now moved by the drive device 10 into the open position according to FIG. 3.

A further resetting of the carrier slide 4 and hence of the closing cover 3 out of the open position into the closed position is achieved by a further actuation of the drive device 10 by the control unit 9, which initiates the closing operation of the closing cover 3 depending on additional sensor signals. Corresponding additional sensor signals may be generated by detection of the ending of the charging process, in particular by removal of the charging cable, by a timer element when the closing cover 3 is open while inactive, or by the passenger vehicle being shifted into gear. The detection of corresponding functionalities to operate the drive device 10 for the closing cover 3 is known per se, so that this is not dealt with in detail here.

1. A closing device for a charging opening of a motor vehicle having an outer bodywork surface, the closing device comprising:
a closing cover having an outer panel matched to the outer bodywork surface of the vehicle and a carrier slide, the outer panel being held on the carrier slide and being movably mounted relative to the carrier slide;
a guide device arranged fixed to the vehicle in a state assembled ready for operation, the guide device being coupled to the closing cover for moving the closing cover between a closed position sealing the charging opening and an open position moved inwards behind the outer bodywork surface relative to the charging opening;
a drive device for moving the closing cover between the closed position and the open position; and
an electric switching element for activation of the drive device, the switching element being arranged between the outer panel and the carrier slide such that a pressure applied from outside onto the outer panel leads to an actuation of the switching element.

2. The closing device according to claim 1, wherein the switching element is fastened to the carrier slide.

3. The closing device according to claim 1, further including a control unit controlling the drive device, the switching element being coupled wirelessly or by wire to the control unit.

4. The closing device according to claim 1, wherein the switching element has a mechanical switching member or a Hall sensor or a sensor element for detecting a movement of the outer panel.

5. The closing device according to claim 1, further including a spring arrangement, the spring arrangement resetting the outer panel into a non-loaded initial position as soon as the load from outside is no longer being applied.
